(19) United States
(12) Patent Application Publication
(10) Pub. No.: US 2017/0132666 A1
(43) Pub. Date: May 11, 2017

(54) PROVISIONING A TRANSACTION MANAGEMENT SYSTEM TO PROVIDE FOR PRODUCT OFFERINGS BASED ON EPISODIC EVENTS

(71) Applicant: Sure, Inc., San Diego, CA (US)

(72) Inventor: Wayne Slavin, Santa Monica, CA (US)

(21) Appl. No.: 15/340,263

(22) Filed: Nov. 1, 2016

Related U.S. Application Data
(60) Provisional application No. 62/252,105, filed on Nov. 6, 2015.

(51) Int. Cl. G06Q 30/02

(52) U.S. Cl. CPC G06Q 30/0267; G06Q 30/0261

(57) ABSTRACT

In one implementation, a method is provided. The method includes receiving, at a server processing device, data for a geographic location associated with a targeted user mobile device. A database of episodic events corresponding to the geographic location is searched. A qualifying episodic event corresponding to the geographic location is identified in the database. A product offering specific to the qualifying episodic event is selected. Thereupon, the product offering is delivered to the targeted user mobile device.

### CROSS REFERENCE TO RELATED APPLICATION

This application claims the benefit of U.S. Provisional Application No. 62/252,105, filed Nov. 6, 2015, the entire disclosure of which is incorporated herein by this reference.

### TECHNICAL FIELD

The subject matter described herein relates to content delivery services, and more specifically, to provisioning a transaction management system to provide for product offerings based on episodic events.

### BACKGROUND

Premium payments related to an insured's ability to recover from particular events are usually based on, for example, various types of losses that can occur because of certain accidents. Traditional recovery models are periodic and/or property based. In some periodic payment models, the insured makes periodic premium payments (e.g., monthly or yearly) to protect against loss during a specified period (e.g., the subsequent month or year). Under property-based models, the insured makes a premium payment (which can be paid one time or can be periodic) to protect specific property against loss. In some situations, sudden events may come up in which an insured may want an immediate or on-demand provisioning of services to be protected from losses related to that event. In such situations, however, companies that determine premiums for such services may be exposed to significant losses if a large number of the insured are congregated in particular areas or engaging in common geo-located events.

### DESCRIPTION OF DRAWINGS

The disclosure is illustrated by way of example, and not by way of limitation, and will become apparent upon consideration of the following detailed description, taken in conjunction with the accompanying drawings, in which like reference characters refer to like parts throughout, and in which:

FIG. 1 is a system block diagram illustrating an example system in which implementations of the disclosure may operate.

FIG. 2 is a pictorial diagram of a system including a plurality of client devices in accordance with aspects of the disclosure.

FIG. 3 is a pictorial diagram illustrating an example of a system to provide for episodic events based on geo-location data in accordance with aspects of the disclosure.

FIG. 4 is a data flow diagram illustrating an implementation of a method of providing for episodic events in accordance with implementations of the disclosure.

FIG. 5 illustrates a diagrammatic representation of a machine in the exemplary form of a computer system.

### DETAILED DESCRIPTION

Provisioning a transaction management system to provide product offerings based on episodic events is disclosed herein. It is contemplated that the systems and methods described herein may be provisioned for delivery of any product offering triggered, for instance, by detection of a qualifying episodic event. However, so as to illustrate system functionality and corresponding processing of actionable data, and not by way of limitation, the product offering described herein is an exemplary insurance product. It is envisioned that one skilled in the art could make and use the system described herein to offer a plurality of product offerings in response to identified episodic events based in part, but not necessarily necessitated by, the geo-location of a mobile device.

An episodic event may be specific activities with limited time durations. For example, a user booking a flight to a destination may be an episodic event. In this example, one or more product offerings may be provided to insure the user against accidental losses associated with scheduled airline flight (e.g., wheels-up to wheels-down). In some implementations, product offerings may be provided upon identifying but before the user engages in a particular activity. For example, product offerings may be provided to the user soon before boarding the scheduled airline flight. In some implementations, the transaction management system may be configured to dynamically de-concentrate the amount of products (e.g., insurance products prior to a scheduled airline flight) delivered to users in a given area.

In the example case of insurance products, dynamic risk de-concentration can limit the amount of underwriting risk assumed for any qualifying related activity. This allows the transaction management system to adjust product offerings and provide a mechanism to protect the insurance carrier against potentially large losses associated with any qualifying episodic event. For example, the system may use certain contextual data, such as the geographic location (e.g., geo-location) of the user's mobile device to evaluate potential maximum losses related to an episodic event. This geo-location information also allows the system to determine appropriate product premiums and other terms (or refrain from offering the product to the user) for the products. In some cases, requests for insurance products from co-located individuals may be denied if a captive limit for that product for the location is met. For example, an insurance carrier may wish to limit the number of people they insure for accidental death resulting from certain events, such as terrorism at a certain venue for a particular sporting event (e.g., specific place and time), an accident associated with an individual flight, or other types of events.

In some implementations, the current subject matter enables the transaction management system to track all insurance products issued per episodic event, electronically and in real time, while employing any number of de-concentration strategies to avoid the risk exposure associated with having a large number of delivered products in a given geo-location or given episodic event. These de-concentration strategies can then be quickly deployed by analyzing data from the mobile devices of the users against changing product variables as potential threshold factors are breached. This de-concentration mechanisms can include, for example, limiting the number of products issued, introducing any number of additional underwriting resources that have their own set of parameters, imposing progressive premium increases, imposing higher deductibles for certain products, offering different product if the user chooses other options related to the episodic event (such as a different time or place) and other type of de-concentration strategies to limit potential losses.

In some implementations, the current subject matter can detect information about a user, such as the geo-location of the users, bank account transactions, retail purchases, etc., to determine the appropriate insurance product offerings for the qualifying episodic event associated with the user. Traditionally, carriers issue products to consumers predicated on the appropriate product filing and applicable regulations of jurisdiction in which the consumer is domiciled. To file a product nationally can take years to achieve and most products never get approval in all 50 states. Without an appropriate product filing, an insurance carrier is forbidden from selling in unlicensed territories, thus creating a problem for brokers or agents working for single insurance carriers, as they are unable to sell products in every state. The transaction management system as disclosed herein can act as an aggregator where necessary by offering products from any number of insurance carriers as may be required to maximize the coverage to its customers.

Based on the geo-location of the users as indicated by their client devices, the transaction management system can determine which insurance products are available in that geo-location and automatically issue a product offering from the appropriate carrier in real-time. Although the insurance products offered may be different depending on the location of the users, the transaction management system can provide a user experience that remains unchanged and seamless to the consumer, regardless of the particular carrier associated with the product. As an example, although a first insurance carrier may have an approved $1,000,000 flight insurance product within a first jurisdiction, they may not have the same product available in a second jurisdiction. When a user is in the second jurisdiction, however, the transaction management system of the disclosure can issue customers a product from a second insurance carrier or any other insurance carrier that provides the same or similar benefits. This allows the system to be agnostic to the back-end insurance carrier supporting the products and even create a marketplace where carriers can bid on the products.

In situations where the transaction management system has not partnered with as carrier that has an approved insurance product in a particular state, the system can be configured to block access to that particular product or remove it from the list of available products. All other products approved in that state are still available to the user. If the transaction management system, for example, does not have the ability to sell flight insurance in a certain jurisdiction, then a consumer accessing the transaction management system while in the jurisdiction will not see the flight product available for sale. Consumers in other states where the product is available will, however, be able to purchase a product via the transaction management system for qualifying episodic events.

In the following description, numerous details are set forth. It will be apparent, however, to one skilled in the art, that the disclosure may be practiced without these specific details. In some instances, well-known structures and devices are shown in block diagram form, rather than in detail, in order to avoid obscuring the disclosure.

The disclosure is related to a system for performing the operations herein. This system may be specially constructed for the required purposes or it may comprise a general purpose computing device selectively activated or reconfigured by a computer program stored therein. Such a computer program may be stored in a non-transitory computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

In some implementations, the computer program product, or software may include a non-transitory machine-readable medium having stored thereon instructions, which may be used to program a computer system (or other electronic devices) to perform a process according to the disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (non-propagating electrical, optical, or acoustical signals), etc.

Although aspects of the disclosure may be described as being provided in real time or substantially real time, it should be noted that some products with “flat” information profiles (e.g., flight accident insurance) are provided within moments (e.g., less than minute). This is typically after the submission of relevant information by the user. For other products that may have variable underwriting inputs, further system processing may be needed or a final authentication and confirmation, if certain conditions are flagged based on the user inputs or other conditions. In such cases, the products can be issued in less than few minutes, although longer times are possible depending on the particular circumstances related to the episodic event.

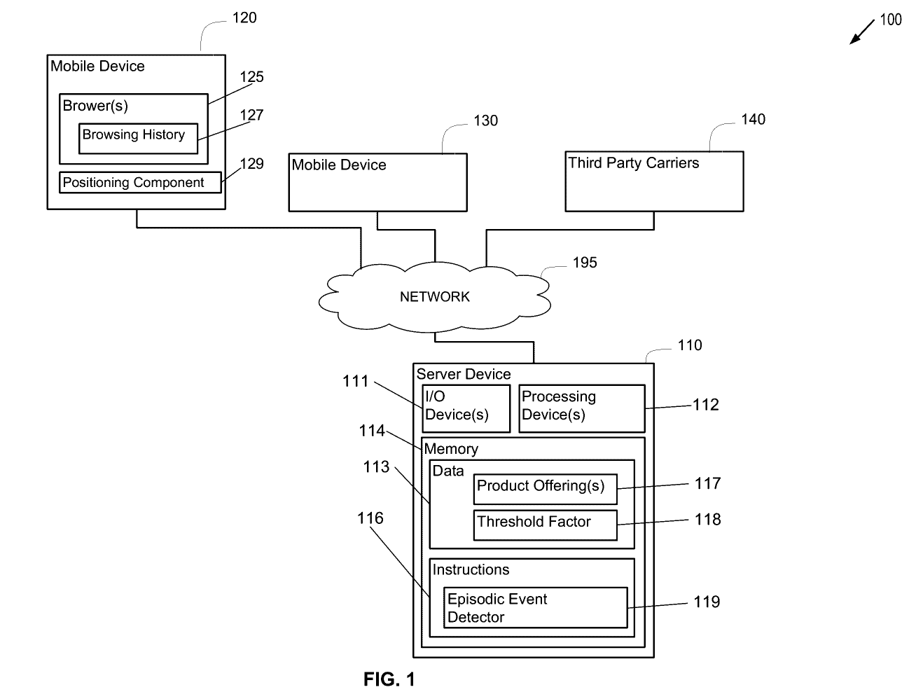

FIG. 1 is a system block diagram illustrating an example system 100 in which implementations of the disclosure may operate. In some implementations, the system 100 may be a transaction management system to provide products for episodic events associated with user mobile devices. As shown, the system 100 includes a plurality of client computing devices, such as mobile devices 120 and 130, coupled to network 195, and one or more server computing devices, such as server device 110, capable of communicating with the client computing devices 120 and 130 over the network 195. In some implementations, the network 195 may be a private network (e.g., a local area network (LAN), Wi-Fi, Bluetooth, Radio Frequency), a wide area network (WAN), intranet, etc.), or a public network (e.g., the Internet).

Server device 110 may be at one node of network 195 and capable of directly and indirectly communicating with other nodes of the network 195. For example, the server device 110 may include a web server that may be capable of communicating with mobile devices 120 and 130 via network 195 such that it uses the network 195 to transmit/deliver and display information to a participant on a display associated with mobile devices. In some implementations, the server device 110 may also include a plurality of computers that exchange information with different nodes of a network for the purpose of receiving, processing and transmitting data to the mobile devices 120 and 130.

Referring to FIG. 1, the computing devices of system 100, such as server device 110, may include one or more I/O (input/output) devices 111, processors 112, memory 114, and other components typically present in general purpose computers. “Processor” or “Processing device” herein refers to a device capable of executing instructions encoding arithmetic, logical, or I/O operations. In one illustrative example, a processor may include an arithmetic logic unit (ALU), a control unit, and a plurality of registers. In a further aspect, a processor may be a single core processor that is typically capable of executing one instruction at a time (or process a single pipeline of instructions), or a multi-core processor that may simultaneously execute multiple instructions. In another aspect, a processor may be implemented as a single integrated circuit, two or more integrated circuits, or may be a component of a multi-chip module (e.g., in which individual microprocessor dies are included in a single integrated circuit package and hence share a single socket). A processor may also be referred to as a central processing unit (CPU). “Memory” herein refers to a volatile or non-volatile memory device, such as RAM, ROM, EEPROM, or any other device capable of storing data. “I/O device” herein refers to a device capable of providing an interface between a processor and an external device capable of inputting and/or outputting binary data. Although, for simplicity, a single processor 112 is depicted in FIG. 1, in some other implementations computer system 100 may comprise a plurality of processors. Similarly, in some other implementations computer system 100 may comprise a plurality of I/O devices, rather than a single I/O device 111.

Instructions 116 of the server device 110 may be a set of instructions to be executed directly (such as machine code) or indirectly (such as scripts) by the processor 112. In that regard, the terms “instructions,” “steps” and “programs” may be used interchangeably herein. The instructions 116 may be stored in object code format for direct processing by the processors 112, or in another computer language including scripts or collections of independent source code modules that are interpreted on demand or compiled in advance.

Data 113 may be retrieved, stored or modified by processors 112 in accordance with the instructions 116. For instance, although the present disclosure is not limited by a particular data structure, the data 118 may be stored in computer registers, in a relational database as a table having a plurality of different fields and records, XML documents, or flat files. The data 113 may also be formatted in a computer-readable format such as, but not limited to, binary values, ASCII or Unicode. By further way of example only, the data 113 may comprise information sufficient to identify the relevant information, such as numbers, descriptive text, proprietary codes, pointers, references to data stored in memory or information that is used by a function to calculate the relevant data. For example, the data 113 may include information of a plurality of product offerings 117 regarding certain criteria for generating premiums for product offerings related to qualifying episodic events.

In some implementations, the criteria may include a threshold factor 118 defined by, for example, third party carries 140 offering the product offerings 117. In one implementation, the threshold factor 118 that may place limits on the number of products that can be delivered when the factor is met. This threshold factor 118 may include, for example, a user capacity value, a risk value and a monetary value associated with an accumulated number of qualifying episodic events delivered in a given geo-location or for the event. In some implementations, certain elements of the product offering may be adjusted prior to delivering the product offerings 117 to the user's client device in view of the threshold factor 118. For example, system 100 may adjust (e.g., increase or decrease) premiums for these products depending on how close the threshold factor 118 is to being met for that product.

To obtain information regarding certain criteria associated with the plurality of product offerings 117, the system 100 may be in communication with third party carriers 140. For example, the third party carriers can include computing systems operated by insurance carriers that include APIs for interacting with system 100. In some implementations, system 100 may receive information from the third party carriers 140 and store (for example, in memory 114) various schedules of rates and product policies of the third party carriers 140.

In some situations, a user of a mobile device, such as mobile device 120, can protect against losses due to certain activities (e.g., accidental death insurance for an airplane flight) on demand through interacting with system 100. In this regard, software can be provided on the mobile device 120 that can display available products to the user. The software allows for user-initiated actions, such as inputting information, register, requesting a premium quote, obtaining products, submitting a claim, and the like, e.g., via text, by uploading images, etc. This communication with the mobile device 120 may be bi-directionally with one or more servers, such as server device 110, of the system 100.

In some implementations, each mobile device may include an application (e.g., browser 125) to facilitate different types of electronic communications between the mobile devices 120 and 130 and the server device 110 via network 195. In one implementation, the application may be installed and/or a service may be selected in order to obtain the benefits of the techniques described herein. In an implementation, the application may be downloaded onto the mobile device 120 or 130. For example, a user may elect to download the application from a service associated with an online server. The mobile device 120 or 130 may transmit a request for the application over network 195 and, in response, receive the application from the service.

The user may enter a search query using, for example, application or browser 125 on a display of the mobile device 120. The user's query may include information for scheduling information related to the episodic event, such a car or flight booking. In some implementation, this information related to the episodic event may be received by the server device 110 from the mobile device 120. Based on the received information, the system may detect certain location information associated with the episodic event. For example, user's query may include information such as a time and place of the episodic event. In other implementations, the server device may receive or access the user's browsing history 127 for signals indicating a specific time period and place associated with the episodic event. For example, this browsing history 127 may include, for example, location history of the mobile device 120, banking transactions associated with the user, retail purchase history, etc. In some implementations, the user's navigation history may indicate that the user has viewed airline or car bookings for the location for a specific date or other type of browsing activities which can be used as an indicator to determine a specific time period related to the episodic event.

In some implementations, the system can detect certain location information associated with the episodic event based on the user's mobile device For example, mobile device 120 may include a positioning component 129 (such as circuits) to determine the location of the device. For example, the mobile device 120 may include a GPS positioning component or receiver. By way of example only, the positioning component 129 may include software for determining the position of the device based on other signals received at the mobile device 120, such as signals received at a cell phone's antenna from one or more cell phone towers if the mobile device is a cell phone. In some implementations, the system 100 may determine what product offerings 117 are available to the user associated with the mobile device 120 to protect against losses related to certain qualifying episodic events. The system may then determine and adjust premiums for these products by filtering thru them for relevancy to a particular product for the user based on at least the location information associated with the user's mobile device and the mobile device of other users in the area already subscribed to the product.

To facilitate the provisioning of system 110 to identify products and determine premiums for those products for specific episodic events, the server device 110 may include episodic event detector 119. The episodic event detector 119 may detect the location of a user and search, for example, in a database of system 100, for a qualifying episodic event associated with this location. Once the qualifying episodic event is identified, the episodic event detector 119 may select product offerings 117 and corresponding premiums specific to the event that can be delivered to the user on a display of their client devices, such as client devices 120 and 130. The functionality of this module 119 can exist in a fewer or greater number of modules than what is shown, with such modules residing at one or more computing devices, which may be geographically dispersed. The systems may be operable in conjunction with components of system 100, such as the client devices 120 and 130 and the third party carriers 140, from which it may receive related data and other relevant information to provide for various episodic events.

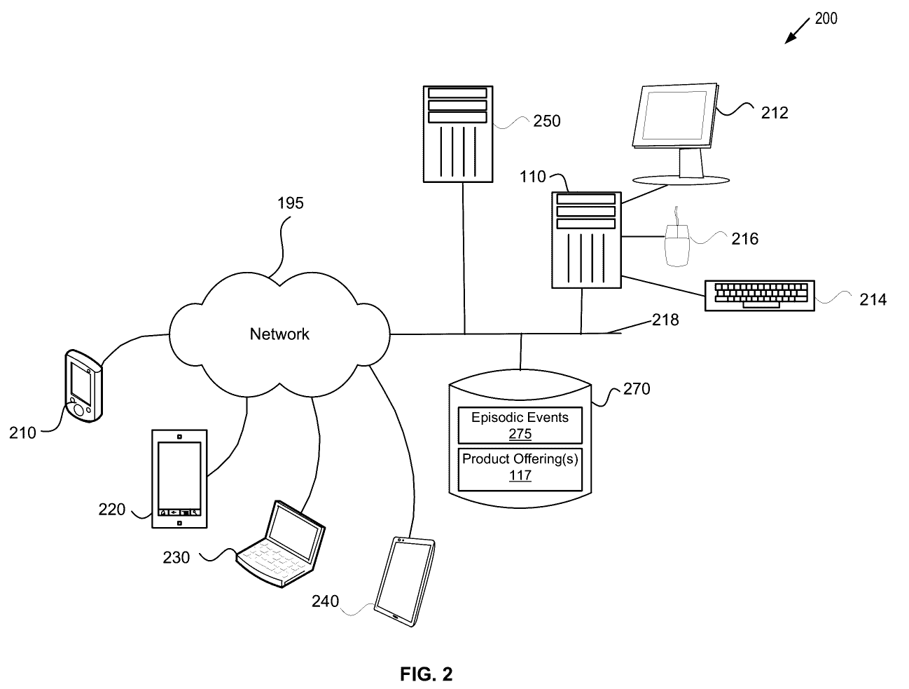

FIG. 2 is a pictorial diagram of a system 200 including a plurality of client devices 110, 210, 220, 230, 240 and 250 in accordance with aspects of the disclosure. In some implementations, the system 200 comprises a computing platform that can employ one or more mitigation strategies to provide for losses related to certain episodic events. As shown, FIG. 2 illustrates a network 195 having a plurality of computing devices, such as server device 110, other types of computing devices, a personal data assistant (PDA) 210, a smartphone 220, a laptop/netbook 230 and a tablet 240 as well as computing server devices, such as computing device 250. The various devices may be interconnected via a network or direct connection 218 and/or may be coupled via a communications network 195 (e.g., a LAN, WAN, the Internet, etc. that may be wired or wireless). In some implementations, the computing devices may communicate with each other before accessing the communication network 195.

Each device may include, for example, user input devices such as a keyboard 214 and mouse 216 and/or various other types of input devices such as pen-inputs, joysticks, buttons, touch screens, etc., as well as a display, which could include, for instance, a CRT, LCD, plasma screen monitor, TV, projector, touch screen, etc. Each device may be a personal computer, application server, etc. By way of example only, computing device 220 may be a mobile phone while computing device 110 and 250 may be a server. Databases, such as database 270, may be accessible to one or more of the computing devices or other devices of system 200. The database 270 may comprise data, such as various episodic events 275 and product offerings, such as product offerings 117, for these events, third party carrier information, mobile device data as well as other relevant information to provide products and premium amounts for the products to a display of the mobile devices for selection by the user via system 200.

In some implementations, the computing platform 200 can analyze positioning data against certain criteria (for example, as specified by a third party carrier) and changing product variables stored in database 270 to de-concentrate potential losses for the third party carriers in particular geo-locations or particular episodic events. In some situations, the third party carriers may specify a threshold factor indicating an amount of potential losses that they desire to carry per product associated with an episodic event. In other situations, system 200 may determine a capacity limit associated with the products based on third party provider information and the mobile/client devices, such as devices 210-240 of other users already subscribed to the product. These capacity limits may be based on a aggregate amount of potential losses in a corresponding geo-location or the number of products issued in a certain area or for a certain event, or limits on a start time of certain events (e.g., flight departure time) to obviate adverse selection by the user once the episodic event has begun. Further example of providing for events using the techniques disclosed herein are further discussed below.

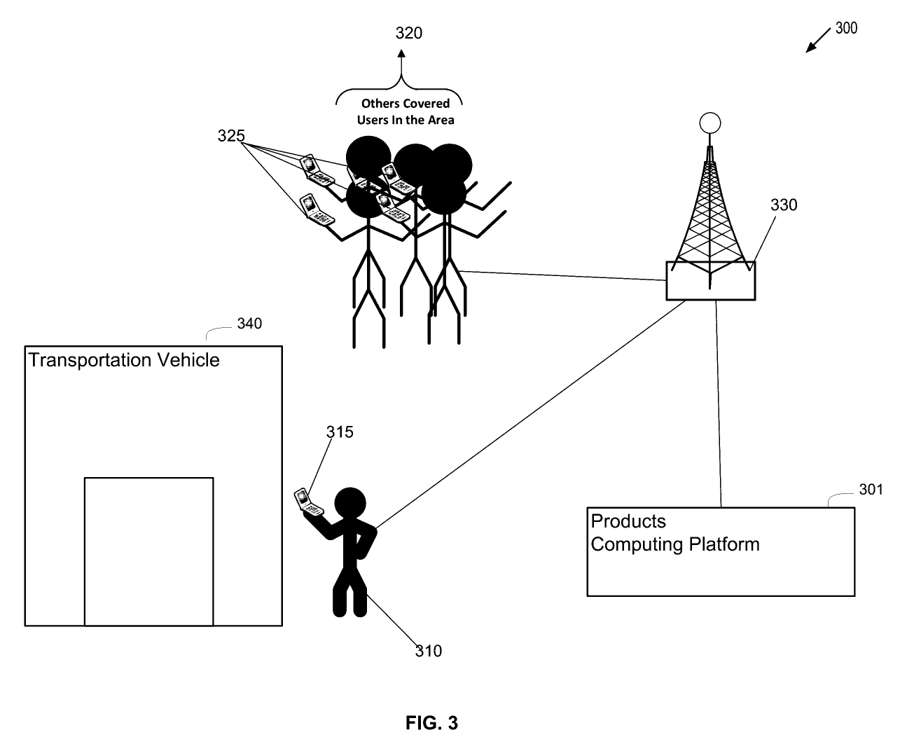

FIG. 3 is a pictorial diagram illustrating an example of a system 300 to provide products for episodic events based on geo-location data in accordance with aspects of the disclosure. In this example, the system 300 includes a products computing platform 301 to provide products for various qualifying episodic events. The products computing platform 301 may be compared to system 100 of FIG. 1 and system 200 of FIG. 1. For example, the products computing platform 301 may include a plurality of computing devices that can communicate with mobile devices of users, such as mobile device 315 of user 310 and mobile devices 325 of users 320 over a network connection, such as network connection 330. In some implementations, the products computing platform 301 may perform a de-concentration of an aggregate amount of estimated losses associated with a number of delivered products to the users in certain areas.

In an illustrative example using system 300, user 310 may begin a search on mobile device 315 for a specific type of product. The search is then transmitted from the mobile device 315 to the products computing platform 301. In some implementations, the search for products may be initiated based on an indication received from the mobile device 310 that the user may desire protection for an upcoming episodic event. For example, the indication may be based on a context of the mobile device 310 (for example, when the mobile device 310 enters a geographically proximal region to a location of a transportation vehicle 340 (e.g., a flight or car rental). In such cases, the products computing platform 301 may present on the mobile device 315 of user 310 a suggestion of certain products (e.g., accidental death insurance) for the plan trip. In this regard, the mobile device 310 may transmit geo-location information to the products computing platform 301 to determine a correspondence between the user's location and a location of the episodic event.

In some implementations, the platform 301 determines which products are available for the episodic event based on the user's geo-location and other search parameters. For example, a geometrical intersection algorithm can be employed by the platform 301 to determine in which jurisdiction the user 310 is located. Once the jurisdiction is determined, the available products can be determined and the available products in that jurisdiction can be returned to the mobile device 315. For example, the platform 301 may filter the products in the jurisdiction for relevancy to the user based on at least the location information of the user 310 as indicated by the mobile device 315.

In some implementations, the products computing platform 301 may identify a plurality of products to provide for losses related to the episodic event based on certain criteria and available inventory/quota allowances provided by the third party carriers. The products computing platform 301 can identify the episodic event (such as a plane flight or a concert) and track how many products have been already issued for this event electronically and in real time.

As an example, events can be tracked based on purchase receipts received by the products computing platform 301 via email or the browsing history of client device 310. For example, the products computing platform 301 can identify and track events by analyzing purchases made for tickets associated with the episodic event. In one implementation, the products computing platform 301 can provide products that protect against the episodic event being canceled, delayed or not received in cases where the event is the purchase of an item for sale. In other implementations, the products computing platform 301 can connect to other on-line services to automatically detect a time period in which the episodic event is to occur. Based on the information received, the platform 301 may then determining whether the plurality of products provide for losses related to the episodic event during that time period.

This determination may also be based on additional criteria and/or contextual information. In some implementations, the additional criteria can include, for example, whether a quota of available policies has been reached. The contextual information can include, for example, whether the transportation vehicle 340 associated with episodic event in question has already departed (at which point a product will be determined not to be available). In some aspects, the contextual information can include location data related to nearby beacons or Wi-Fi networks 330 to more accurately determine the user's location. In some aspects, the contextual information can include data from sensors on the user's device, such as fitness data for the user collected from the device or a synchronized wearable device. In some cases, the sensor data may include motion sensor data to detect whether a device that the customer wants to purchase product to cover has been dropped recently.

In some implementations, the platform 310 calculates the availability of products of the episodic event based on information from a single primary third party carrier or multiple carriers operating in a pass through or quota share arrangement. For example, the platform searches for available product based on capacity limits received from the primary and secondary carriers. This can include the primary carrier providing capacity limits (e.g., amount of losses or number of issued products) for each type of product associated with the episodic event. In some implementations, the platform 310 sources additional capacity from secondary insurance carriers for the relevant products.

If no products are available for the episodic event (for example, due to lack of capacity as dynamically determined for de-concentration), the user 310 may receive an alert indicating various options to change their search parameters. If products are available and appropriately de-concentrated, information regarding the products is transmitted to the mobile device 315 for display to the user 310. In some implementations, the product details and an estimate of the available quantities for that products is shown to the user. In this regard, the user 310 may select one or more products from the list of available products. Thereafter, the mobile device 315 transmits the selection to the platform 301. In response, the platform 301 via the mobile device 315 presents to the user 310 with a form or series of forms to be completed with user-specific data required for the product. The user 310 may complete the forms on the mobile device 310, which then transmits the data to the platform 301 for further processing.

In some implementations, the platform 301 determines and transmits to the mobile device 310 for selection by the user the available products and a premium amount for the product associated with the episodic event. This premium amount can be a stored/fixed pricing or dynamic determined based on the user's data or inventory availability. In one implementation, the platform 301 may determine whether any of other users 320 associated with a number of other client devices 325 are also participating in the episodic event based on the location information of their device. In this regard, the premium amount for the product may be adjusted to account of the additional products in the area or the user 310 may be denied the product.

If the product is offered, the user 310 can select a product plan/price to proceed with the process. Product plans can differ in amount of payouts, features included with the product, and/or an amount of a deductible associated with the product. In some implementations, the mobile device 310 displays to the user 310 a checkout screen with a summary of their selections. The user 310 may enter payment details or if the payment details are previously saved they are displayed by mobile device 310. The user 310 may submit their order that is then transmitted to platform 310, which performs the payment processing. If the charge fails, the user 310 may be returned to the checkout screen. If the charge is successful, the product is issued and a confirmation is transmitted to mobile device 310 for the user.

In another illustrative example using system 300, the user 310 submits a search, including information (for example, time frame, location, and the like) for a type of product to provide for an episodic event, using mobile device 310. In this regard, the mobile device 310 determines and transmits the user's geo-location to the platform 301. The platform 301 may search a database, such as database 270 of FIG. 2, for a qualifying episodic event corresponding to the geo-location of user 310. The platform 301 may then determine which products are available for this qualifying episodic event. For example, a geometrical intersection algorithm can be employed by the platform 301 to determine which jurisdiction the user 310 is located. Once the jurisdiction is determined, the available products for that jurisdiction can be delivered to the mobile device 110 for selection by the user 310.

Although a few variations have been described in detail above, other modifications or additions are possible. For example, certain carriers may be replaced by capital provided by an entity controlling the systems disclosed herein (e.g., the carriers need not be third party carriers in some implementations). The current subject matter can implement a peer-to-peer insurance model by having a group of other users of the system contributing capital so that peers hold liabilities related to the episodic events.

In some implementations, the users not need make the purchase manually, but rather their email can be scanned, for example, for a flight receipt. In response, a text message, email, and/or application message can be transmitted to the user asking if they want to be insured for the flight. This can be achieved by scraping data from the email and allowing the user to simply place an order by replying to a message or opting in with a single click if their payment details are stored.

In other implementations, the systems can also prevent offering products in view of certain threshold factors. For example, buying of products for certain flights may be unavailable after the scheduled (published) takeoff time. This prevents passengers from buying the product using the plane's Wi-Fi as it is having difficulties. Additionally, weather related conditions can prevent the offering of certain products. For example, if a hurricane is 7 days away from the coast, there is a calculated probability as to whether it will land at a location. As time counts down and the hurricane gets closer to the coast, the probability increases that it may hit in a certain location. Once the probability of a hurricane making landfall is greater than a threshold factor, the system can automatically disable the offering of products to provide products for this episodic event.

In some implementations, the threshold factors may also prevent the offering of products after a determined number of policies have been issued and/or an aggregate monetary value of insurance is sold. Another threshold factor can relate to the overall risk associated with a certain user. For example, if a user is taking insurance on older purchase (such as an older smartphone) as the release of a new smartphone is approaching, the system may determine a risk score associated with the user and provide a policy with a certain deductible. In one implementation, the deductible may be higher than if the user was insuring their older smartphone from the first day of purchase.

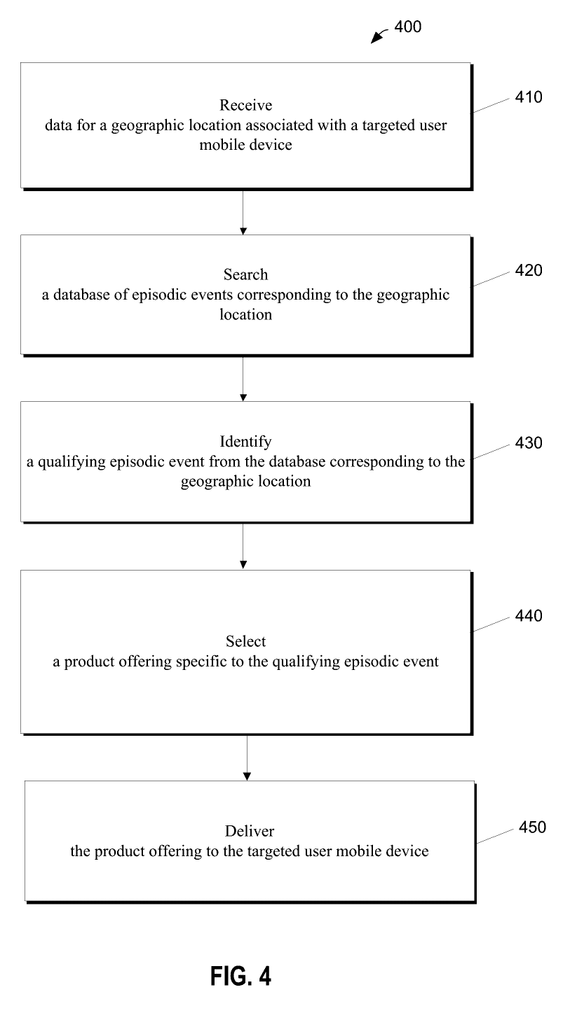

FIG. 4 is a data flow diagram 400 illustrating an implementation of a method of providing for episodic events in accordance with implementations of the disclosure. In one implementation, the processing device 112 of FIG. 0.1 may perform method 400. The method 400 may be performed by processing logic that may comprise hardware (circuitry, dedicated logic, etc.), software (e.g., software executed by a general purpose computer system or a dedicated machine), or a combination of both. In alternative implementations, some or all of the method 400 may be performed by other components of a shared storage system. It should be noted that blocks depicted in FIG. 4 can be performed simultaneously or in a different order than that depicted.

Method 400 begins at block 410 where data for a geographic location associated with a targeted user mobile device is received. In block 420, a database of episodic events corresponding to the geographic location is searched. A qualifying episodic event corresponding to the geographic location is identified from the database in block 430. In block 440, a product offering specific to the qualifying episodic event is selected. Thereupon, the product offering is delivered to the targeted user mobile device in block 450.

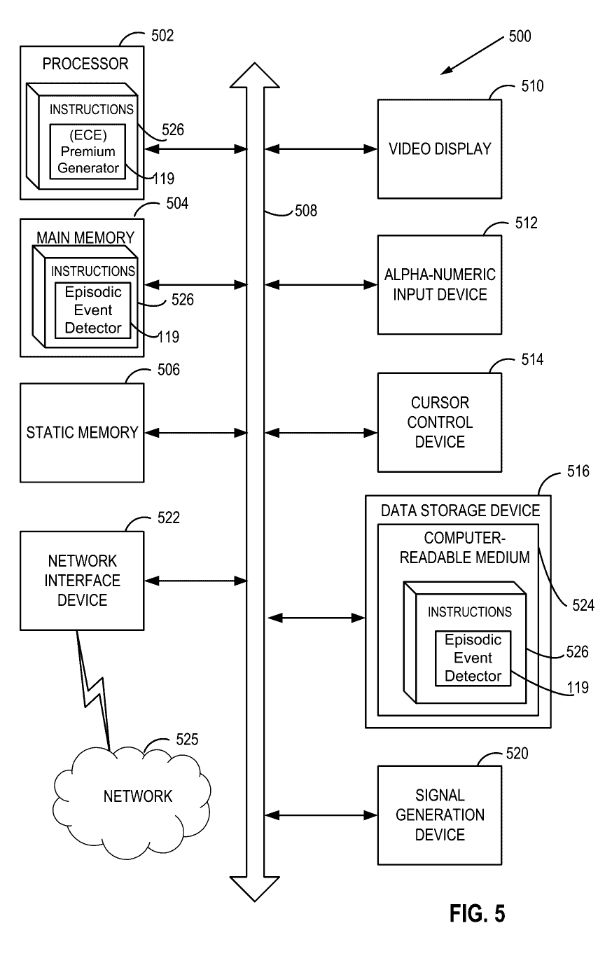

FIG. 5 illustrates a diagrammatic representation of a machine in the exemplary form of a computer system 500 within which a set of instructions, for causing the machine to perform any one or more of the methodologies discussed herein, may be executed. In alternative implementations, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 may be comprised of a processing device 502 (which may correspond to a processing device 112 within system 100 of FIG. 1), a main memory 504 (e.g., read-only memory (ROM), flash memory, dynamic random access memory (DRAM) (such as synchronous DRAM (SDRAM) or Rambus DRAM (RDRAM), etc.), a static memory 506 (e.g., flash memory, static random access memory (SRAM), etc.), and a data storage device 516, which communicate with each other via a bus 508.

In a further aspect, the computer system 500 may include a processing device 502 (which may correspond to processing device 112), a volatile memory 504 (e.g., random access memory (RAM)), a non-volatile memory 506 (e.g., read-only memory (ROM) or electrically-erasable programmable ROM (EEPROM)), and a data storage domain 516, which may communicate with each other via a bus 508.

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. Processing device 902 is configured to execute processing logic (e.g., instructions 526) for performing the operations and steps discussed herein.

Computer system 500 may further include a network interface device 522. Computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

Data storage device 516 may include a machine-readable storage medium (or more specifically a computer-readable storage medium) 524 having one or more sets of instructions 526 embodying any one or more of the methodologies of functions described herein, including instructions encoding the techniques including the episodic event detector 119 of FIG. 1 for implementing method 400 of FIG. 4 for provisioning a transaction management system to provide for episodic events. In some implementations, the episodic event detector 119 may also reside, completely or at least partially, within main memory 504 and/or within processing device 502 during execution thereof by computer system 500; main memory 504 and processing device 502 also constituting machine-readable storage media. The episodic event detector 119 may further be transmitted or received over a network 525 via network interface device 522.

Instructions 526 may also reside, completely or partially, within volatile memory 504 and/or within processing device 502 during execution thereof by computer system 500, hence, volatile memory 504 and processing device 502 may also constitute machine-readable storage media.

While a non-transitory machine-readable storage medium 524 is shown in an exemplary implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the disclosure. The term “machine-readable storage medium” shall accordingly be taken to include, but not be limited to, solid-state memories, and optical and magnetic media.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be in any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

Some portions of the detailed descriptions are presented in terms of algorithms and symbolic representations of operations on data bits within a computer memory. These algorithmic descriptions and representations are the means used by those skilled in the video processing arts to most effectively convey the substance of their work to others skilled in the art. An algorithm is here, and generally, conceived to be a self-consistent sequence of steps leading to a desired result. The steps are those requiring physical manipulations of physical quantities.

It should be borne in mind, however, that all of these and similar terms are to be associated with the appropriate physical quantities and are merely convenient labels applied to these quantities. Unless specifically stated otherwise, as apparent from the above discussion, it is appreciated that throughout the description, discussions utilizing terms such as “receiving”, “searching”, “associating”, “detecting”, “providing”, “filtering”, “selecting”, “delivering”, “processing”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples described herein also relate to an apparatus for performing the methods described herein. This apparatus may be specially constructed for performing the methods described herein, or it may comprise a general-purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods 300 and 400 and/or each of its individual functions, routines, subroutines, or operations. Examples of the structure for a variety of these systems are set forth in the description above.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

What is claimed is:

1. A computer-implemented method, comprising:
receiving, at a server processing device, data for a geographic location associated with a targeted user mobile device;
searching, by the server processing device, a database of episodic events corresponding to the geographic location;
identifying in the database, by the server processing device, a qualifying episodic event corresponding to the geographic location;
selecting, by the server processing device, a product offering specific to the qualifying episodic event; and
delivering, by the server processing device, the product offering to the targeted user mobile device.

2. The computer-implemented method of claim 1, further comprising:
identifying, by the server processing device, a threshold factor corresponding to the product offering; and
adjusting, by the server processing device, elements of the product offering prior to delivering the product offering to the targeted user mobile device in view of the threshold factor.

3. The computer-implemented method of claim 2, wherein the threshold factor is a user capacity value associated with the qualifying episodic event as defined by a third party provider of the product offering.

4. The computer-implemented method of claim 2, wherein the threshold factor is a risk value associated with the qualifying episodic event as defined by a third party provider of the product offering.

5. The computer-implemented method of claim 2, wherein the threshold factor is a monetary value associated with the qualifying episodic event as defined by a third party provider of the product offering.

6. The computer-implemented method of claim 1, wherein the qualifying episodic event is a scheduled airline flight.

7. The computer-implemented method of claim 1, wherein the product offering is an insurance product specific to the qualifying episodic event.

8. The computer-implemented method of claim 1, wherein selecting the product offering comprises processing user-specific data relating to the qualifying episodic event.

9. The computer-implemented method of claim 1, wherein the product offering is delivered to the targeted user mobile device in near real-time.

10. The computer-implemented method of claim 9, wherein delivery of the product offering to the targeted user mobile device is triggered by detection of the qualifying episodic event.

11. The computer-implemented method of claim 1, wherein the product offering is delivered on-demand in response to a user-initiated request via the targeted user mobile device for available product offerings.

12. A system comprising:
a memory; and
a processor, operatively coupled to the memory, to:
receive data for a geographic location associated with a targeted user mobile device;
search a database of episodic events corresponding to the geographic location;
identify, in the database, a qualifying episodic event corresponding to the geographic location;
select a product offering specific to the qualifying episodic event; and
deliver the product offering to the targeted user mobile device.

13. The system of claim 12, wherein the processor is further to:
identify a threshold factor corresponding to the product offering; and
adjust elements of the product offering prior to delivering the product offering to the targeted user mobile device in view of the threshold factor.

14. The system of claim 13, wherein the threshold factor is a user capacity value associated with the qualifying episodic event as defined by a third party provider of the product offering.

15. The system of claim 13, wherein the threshold factor is a risk value associated with the qualifying episodic event as defined by a third party provider of the product offering.

16. The system of claim 13, wherein the threshold factor is a monetary value associated with the qualifying episodic event as defined by a third party provider of the product offering.

17. The system of claim 12, wherein the qualifying episodic event is a scheduled airline flight.

18. The system of claim 12, wherein the product offering is an insurance product specific to the qualifying episodic event.

19. A non-transitory computer-readable medium comprising instructions that, when executed by a processor, cause the processor to:
receive, by the processor, data for a geographic location associated with a targeted user mobile device;
search a database of episodic events corresponding to the geographic location;
identify, in the database, a qualifying episodic event corresponding to the geographic location;
select a product offering specific to the qualifying episodic event; and
deliver the product offering to the targeted user mobile device.

20. The non-transitory computer-readable medium of claim 19, wherein the processor is further to:
identify a threshold factor corresponding to the product offering; and
adjust elements of the product offering prior to delivering the product offering to the targeted user mobile device in view of the threshold factor.
